(19) United States
(12) Patent Application Publication
(10) Pub. No.: US 2017/0168298 A1
(43) Pub. Date: Jun. 15, 2017

(54) DISPLAY DEVICE, FOR A MOTOR VEHICLE

(71) Applicant: Johnson Controls Automotive Electronics SAS, Cergy Pontoise Cedex (FR)

(72) Inventors: Yves Lambert, Osny (FR); Giany Pitte, Osny (FR); Michael Autissier, Taverny (FR); David Renaudin, Us (FR)

(21) Appl. No.: 15/307,373

(22) PCT Filed: Apr. 29, 2015
(86) PCT No.: PCT/EP2015/059426

§ 371 Date: Jan. 16, 2017

(30) Foreign Application Priority Data
Apr. 30, 2014 (FR) 14/01011

(51) Int. Cl. G02B 27/01; B60R 1/00; B60K 35/00

(52) U.S. Cl. CPC G02B 27/0149; B60K 35/00; B60R 1/001; G02B 2027/0154; B60K 2350/2052; B60K 2350/1072

(57) ABSTRACT

A display device for a motor vehicle includes: a projection module, configured to generate an image for projection in a direction of vision of a user of the display device along an optical path; a reflection and/or display element, configured to be displaced between a rest position and at least one display position; and a support for the reflection and/or display element, wherein the reflection and/or display element is configured to be displaced between its rest position and its at least one display position by the support. The reflection and/or display element and the support are connected via first, second, third and fourth surfaces, the first and second surfaces being curved surfaces having a first radius, and the third and fourth surfaces being planar or curved surfaces having a second radius, the second radius corresponding to at least double the first radius.

### CROSS-REFERENCE TO RELATED APPLICATIONS

This application is a U.S. National Phase application under 35 U.S.C. §371 of International Application No. PCT/EP2015/059426, filed on Apr. 29, 2015, and claims benefit to French Patent Application No. FR 14/01011, filed on Apr. 30, 2014. The International Application was published in French on Nov. 5, 2015 as WO 2015/166011 A1 under PCT Article 21(2).

### FIELD

The present invention relates to a display device, in particular for a motor vehicle.

### BACKGROUND

Display devices of the head up display (HUD) type are known, in particular including the projection of an image towards a windscreen as described in U.S. Pat. No. 5,214,413 or towards a reflection element.

Head up display devices permit information to be projected into the field of view in the space in front of the motor vehicle so that the driver of the motor vehicle can read this information without taking his/her eyes from the space in front of the motor vehicle. At the same time, the information can be read without changing the accommodation of the eyes of the driver of the vehicle.

It is advantageous that—depending on the needs of a user of the vehicle—the reflection and/or display element can be used in a plurality of positions of the head (or eyes) of the user of the vehicle.

One disadvantage of such known prior art devices is that a relatively large amount of effort is required to create the link between the support of a reflection and/or display element and the reflection and/or display element. DE 10 144 491 C2 proposes using a spring but this leads to relatively high costs for the display device.

### SUMMARY

In an exemplary embodiment, the present invention provides a display device for a motor vehicle. The display device includes: a projection module, configured to generate an image for projection in a direction of vision of a user of the display device along an optical path; a reflection and/or display element, configured to be displaced between a rest position and at least one display position; and a support for the reflection and/or display element, wherein the reflection and/or display element is configured to be displaced between its rest position and its at least one display position by the support. The rest position of the reflection and/or display element corresponds to a rest position of the support and the display position of the reflection and/or display element corresponds to a display position of the support. The reflection and/or display element is configured for an at least partially rotational movement between its rest and display positions, and the support is configured for an at least partially translational movement between its rest and display positions. The reflection and/or display element and the support are connected via first, second, third and fourth surfaces, the first and second surfaces being curved surfaces having a first radius, and the third and fourth surfaces being planar or curved surfaces having a second radius, the second radius corresponding to at least double the first radius.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 is a schematic cross-sectional view of a display device in accordance with the present invention;

FIG. 2 is a schematic cross-sectional view of a part of the display device in accordance with the present invention with the reflection and/or display element; and

FIG. 3 is a schematic perspective view of a part of the display device in accordance with the present invention with the reflection and/or display element.

### DETAILED DESCRIPTION

Exemplary embodiments of the present invention provide a head up display device having a reflection and/or display element which is reliably connected to its support at reduced cost.

In an exemplary embodiment, the present invention provides a display device, in particular for a motor vehicle, comprising a projection module to generate an image for projection in the normal direction of vision of a user of the display device along an optical path,
the display device comprising a reflection and/or display element, the reflection and/or display element being able to be displaced between a rest position and at least one display position,
the display device comprising a support for the reflection and/or display element such that the reflection and/or display element is displaced between its rest position and its at least one display position by the support,
the rest position of the reflection and/or display element corresponding to a rest position of the support of the reflection and/or display element and the display position of the reflection and/or display element corresponding to a display position of the support of the reflection and/or display element, the reflection and/or display element carrying out at least partially a rotational movement between its rest and display positions, and the support of the reflection and/or display element carrying out at least partially a translational movement between its rest and display positions, characterised in that
the reflection and/or display element and the support are connected via first, second, third and fourth surfaces, the first and second surfaces being curved surfaces having a first radius, and the third and fourth surfaces being planar or curved surfaces having a second radius, the second radius corresponding to at least double the first radius.

It is thus advantageously possible to produce a link between the reflection and/or display element and it support in a simple and inexpensive manner.

Another preferred improvement of the invention resides in the fact that the first and second surfaces are surfaces of the reflection and/or display element (13) and in that the third and fourth surfaces are surfaces of the support (16) of the reflection and/or display element (13), the first and third surfaces and the second and fourth surfaces being pressed against one another by a spring (18).

Another preferred improvement of the invention resides in the fact that the spring (18) is configured such that the first and third surfaces, and the second and fourth surfaces permit a relative rotational movement between the reflection and/or display element (13) and the support (16).

In one variation of the present invention it is also preferred that the direction of the pressing force of the spring (18) is essentially parallel to the straight line connecting, on the one hand, the point of contact between the first and third surfaces and, on the other hand, the point of contact between the second and fourth surfaces.

One preferred improvement of the invention also resides in the fact that the reflection and/or display element can be positioned in a plurality of different display positions.

One preferred improvement of the invention resides in the fact that between the different display positions of the reflection and/or display element, the reflection and/or display element is subjected to a rotary and/or translational movement.

Still another preferred improvement of the invention resides in the fact that the reflection and/or display element is driven between its rest position and its at least one display position by a motor element.

Other features and advantages of the invention will be apparent upon reading the following description of a particular, non-limiting embodiment of the present invention.

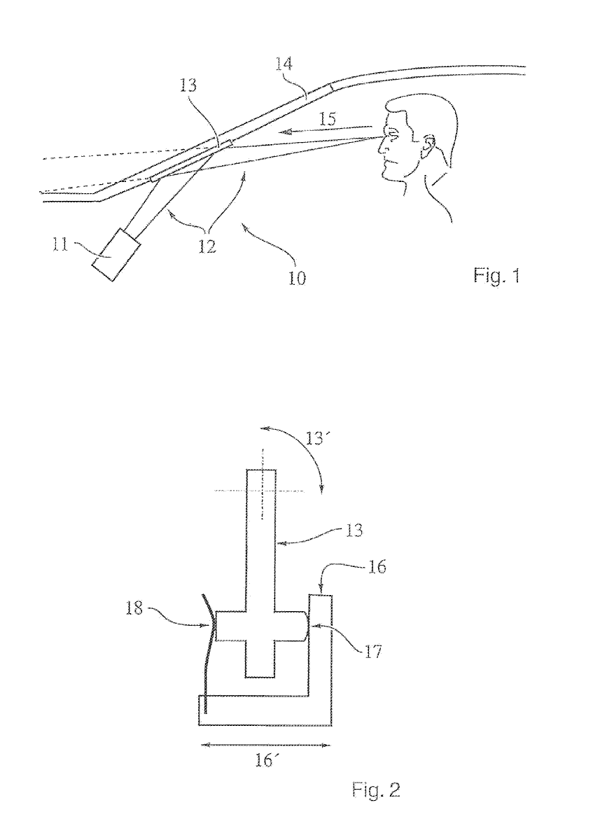

As shown in FIG. 1, a display device 10 in accordance with the present invention comprises a projection module 11 which generates an image in the normal direction of vision 15 of a user of the display device 10 in an optical path 12.

The optical path 12 normally comprises at least one reflection and/or display element 13. In this way, the optical path 12 can comprise a (single) reflection element as shown in FIG. 1. Moreover, the optical path 2 can also comprise two reflection elements. The display device 10 can also be produced with either a reflection element 13 or with a display element (such as for example a thin film transistor (TFT)), or with a reflection and display element.

The normal direction of vision 15 is the direction of view of a user of the display device 10, in particular a vehicle driver, when this person is looking, in particular through a windscreen 14, at the outside area in front of the vehicle.

In accordance with the present invention, the reflection and/or display element 13 is an element positioned spaced apart from the windscreen 14. In accordance with a preferred embodiment of the present invention, the reflection and/or display element 13 can be positioned in a rest position and in at least one display position. When the reflection and/or display element 13 is positioned in its rest position, the reflection and/or display element 13 is e.g. positioned inside a housing of the display device 10.

When the reflection and/or display element 13 is positioned in its display position, the reflection and/or display element 13 is typically positioned upright or virtually vertically so that the user of the display device can look through the reflection and/or display element 13. The change in position of the rest position and the display position of the reflection and/or display element 13 is carried out by a rotational and/or translational movement.

Different positions of the reflection and/or display element 13 can correspond to different display positions and adapted to different heights of the head of the user. The reflection and/or display element 13 is typically driven by a motor element, either directly or via a transmission element. The motor element can in particular be a linear motor element or a rotational motor element, in particular an electric stepping motor element.

In accordance with the present invention, a support element 16 or a support 16 is associated with the reflection and/or display element 13. The support 16 or the support element 16 can be driven between different positioning states, in particular via the motor element.

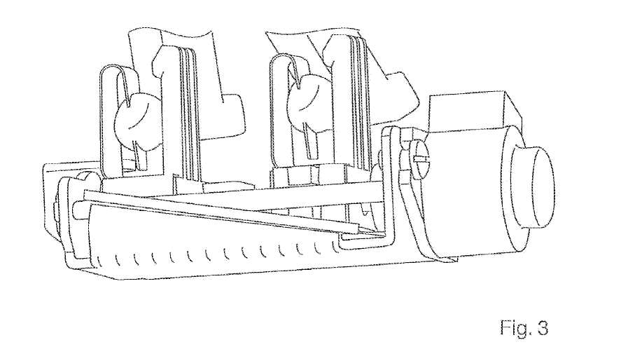

FIG. 2 is a schematic cross-sectional view of a part of the display device in accordance with the present invention. The reflection and/or display element 13 can be rotationally displaced as shown by the arrow 13′. A translational movement of the support 16 of the reflection and/or display element 13 corresponds to the rotational movement as shown by the arrow 16′. In order to permit this movement, a first surface and a second surface are provided on the reflection and/or display element 13; and a third and a fourth surface are provided on the support 13.

The first and second surfaces are surfaces of the reflection and/or display element 13, and the third and fourth surfaces are surfaces of the support 16 of the reflection and/or display element 13.

The first and third surfaces are provided at the location indicated by reference sign 18. The second and fourth surfaces are provided at the location indicated by reference sign 17. At the location of the reference sign 18, a spring is provided to avoid any play between the first and third surfaces, and between the second and fourth surfaces.

The reflection and/or display element 13 and the support 16 are connected by surfaces, the first and second surfaces being curved surfaces having a first (smaller) radius, and the third and fourth surfaces being planar or curved surfaces having a second (larger) radius. According to the present invention, the second radius corresponds to at least double the first radius but in reality clearly greater values for the proportion of the radii are possible. When the third and fourth surfaces are planar surfaces, the radius thereof corresponds to a very high value.

FIG. 3 shows a schematic perspective view of a part of the display device 10 in accordance with the present invention with the reflection and/or display element 13.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

10 display device
11 projection module
12 optical path
13 reflection and/or display element
13′ rotational movement
14 windscreen
15 normal direction of vision
16 support
16′ translational movement
17 location of second and fourth surfaces
18 location of first and third surfaces

1. A display device for a motor vehicle, comprising:
a projection module, configured to generate an image for projection in a direction of vision of a user of the display device along an optical path;
a reflection and/or display element, configured to be displaced between a rest position and at least one display position; and
a support for the reflection and/or display element, wherein the reflection and/or display element is configured to be displaced between its rest position and its at least one display position by support;
wherein the rest position of the reflection and/or display element corresponds to a rest position of the support and the display position of the reflection and/or display element corresponds to a display position of the support;
wherein the reflection and/or display element is configured for an at least partially rotational movement between its rest and display positions, and the support is configured for an at least partially translational movement between its rest and display positions;
wherein the reflection and/or display element and the support are connected via first, second, third and fourth surfaces, the first and second surfaces being curved surfaces having a first radius, and the third and fourth surfaces being planar or curved surfaces having a second radius, the second radius corresponding to at least double the first radius.

2. The display device according to claim 1, wherein the first and second surfaces are surfaces of the reflection and/or display element and the third and fourth surfaces are surfaces of the support; and
wherein the first and third surfaces and the second and fourth surfaces are pressed against one another by a spring.

3. The display device according to claim 2, wherein a spring is configured such that the first and third surfaces, and the second and fourth surfaces, permit relative rotational movement between the reflection and/or display element and the support.

4. The display according to claim 2, wherein a direction of a pressing force of the spring is substantially parallel to a straight line connecting, on the one hand, the point of contact between the first and third surfaces and, on the other hand, the point of contact between the second and fourth surfaces.

5. The display device according to claim 1, wherein the reflection and/or display element is configured to be positioned in a plurality of different display positions.

6. The display device according to claim 5, wherein the reflection and/or display element is configured to be subjected to a rotary and/or translational movement between the different display positions.

7. The display device according to claim 1, wherein the reflection and/or display element is configured to be driven between its rest position and its at least one display position by a motor.
